(19) United States
(12) Patent Application Publication
(10) Pub. No.: US 2013/0266228 A1
(43) Pub. Date: Oct. 10, 2013

(54) AUTOMATIC PART IDENTIFICATION AND WORKFLOW GENERATION

(71) Applicants: David Markson, Arlington, TX (US); Sabir Kader, Coppell, TX (US)

(72) Inventors: David Markson, Arlington, TX (US); Sabir Kader, Coppell, TX (US)

(73) Assignee: SIEMENS INDUSTRY, INC., Alpharetta, GA (US)

(21) Appl. No.: 13/443,041

(22) Filed: Apr. 10, 2012

(51) Int. Cl. G06K 9/68

(52) U.S. Cl. 382/218

(57) ABSTRACT

System, methods, and computer-readable media for automatic part identification and workflow generation. A method includes generating at least one image of a target part using a scanning device. The method includes analyzing the image to determine classification data based on physical characteristics of the target part. The physical characteristics including a size and shape of the target part. The method includes searching a parts database to identify a part that matches the classification data, and generating a workflow based on the identified matching part, including an identification of maintenance to be performed on the matching part.

### TECHNICAL FIELD

The present disclosure is directed, in general, to processes and devices for part maintenance.

### BACKGROUND OF THE DISCLOSURE

Improved systems are desirable.

### SUMMARY OF THE DISCLOSURE

Various disclosed embodiments include systems, methods, and computer-readable media for automatic part identification and workflow generation. A method includes generating at least one image of a target part using a scanning device. The method includes analyzing the image to determine classification data based on physical characteristics of the target part. The physical characteristics including a size and shape of the target part. The method includes searching a parts database to identify a part that matches the classification data, and generating a workflow based on the identified matching part, including an identification of maintenance to be performed on the matching part.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a simplified illustration of the front-end scanner subsystem of a part identification system in accordance with disclosed embodiments;

FIG. 2 depicts a block diagram of a data processing system in which an embodiment can be implemented;

FIG. 3 depicts a flowchart of a process in accordance with disclosed embodiments.

### DETAILED DESCRIPTION

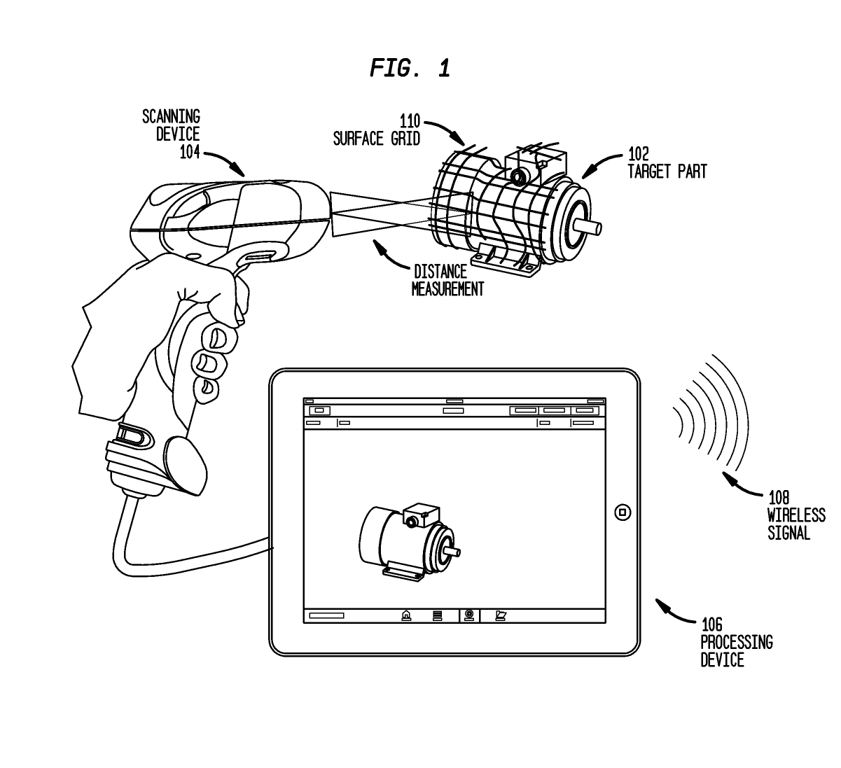

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Various disclosed embodiments include an apparatus and a method to recognize and identify one or more parts or assemblies based upon physical characteristics such as shape, size, color, markings, etc. The identification can then be used to drive a maintenance workflow system.

As systems become ever more sophisticated, they are populated with an increased number of different parts and components, making memorization of all the parts and part numbers a daunting task. If a component fails and needs replacement, the technician must rely on an increasingly large repair manual to identify the part or parts, to learn how to repair or replace that component, and to address a host of other ancillary issues such as the need for specialized tools, supplementary parts, etc.

Disclosed embodiments can automate many of these tasks, saving time and effort and allowing the technician to repair the equipment as fast as possible to return that system to operational capabilities.

Various embodiments can include two primary subsystems. The first subsystem is a front-end scanner preferably implemented as a portable device. The second subsystem is a back-end workflow manager implemented as a data processing system as described herein. The front-end scanner is responsible for obtaining or creating a virtual representation of the targeted part. The back-end workflow manager is responsible for acquiring the data from the front-end scanners and managing the data and workflow of acquiring relevant parts, documentation, interfacing with other subsystems, etc.

FIG. 1 depicts a simplified illustration of the front-end scanner subsystem of a part identification system in accordance with disclosed embodiments. As used herein, “part” is intended to refer to parts, components, assemblies, and similar elements that may be subject to identification, repair, maintenance, or other processes for which automatic identification would be useful.

FIG. 1 illustrates a target part 102 that is to be automatically identified and processed as described herein. As a physical object, the target part 102 will be 3D object with specific physical characteristics.

A handheld scanning device 104 is in communication with, or integrated with, processing device 106. Scanning device 104 is configured to scan and image the target part 102 as described herein, and can project a surface grid 110 onto the target part 102. Processing device 108 can communicate using wireless signal 108 with a data processing system as described below.

Scanning device 104 can include a multi-spectrum analyzer with the ability to “record” relevant data in order to build a virtual model of a targeted part. Scanning device can accomplish this through various scanning techniques. Scanning device 104 can include a laser grid projector that emits a grid pattern onto the target part 102. This serves two purposes in that it provides a target for the operator in which to aim, and that it is used by the optical camera as described below.

Scanning device 104 can also include an optical camera. In various embodiments, a color camera captures two images of the part. The first image is captured while the laser grid is present. The grid image can be transmitted by the processing device 106, below, to the data processing system 200, which can then construct a three-dimensional (3D) representation of the part by analyzing the curves and deviations of the grid and adjusting for surface constructs and the angle of imaging. The second image is captured without the grid and sent to the data processing system 200 in order to obtain coloring data and any words, codes, or other indicia on the surface of the part.

Scanning device 104 can include a distance sensor that measures the distance from the scanning device 104 to the target part 102. This can be used to calculate the true size of the targeted part.

Processing device 106 can be implemented for example, in a tablet computer or cell phone form factor for lightweight and portability reasons. Processing device 106 can capture and store the images and data obtained by the scanning device 104, and can perform other functions such as communicating with the data processing system 200, can display pertinent repair information to a technician, and can provide a remote portal for the technician to interact with the back-end workflow manager implemented as data processing system 200.

In various embodiments, scanning device 104 and processing device 106 can be implemented as a single integrated device.

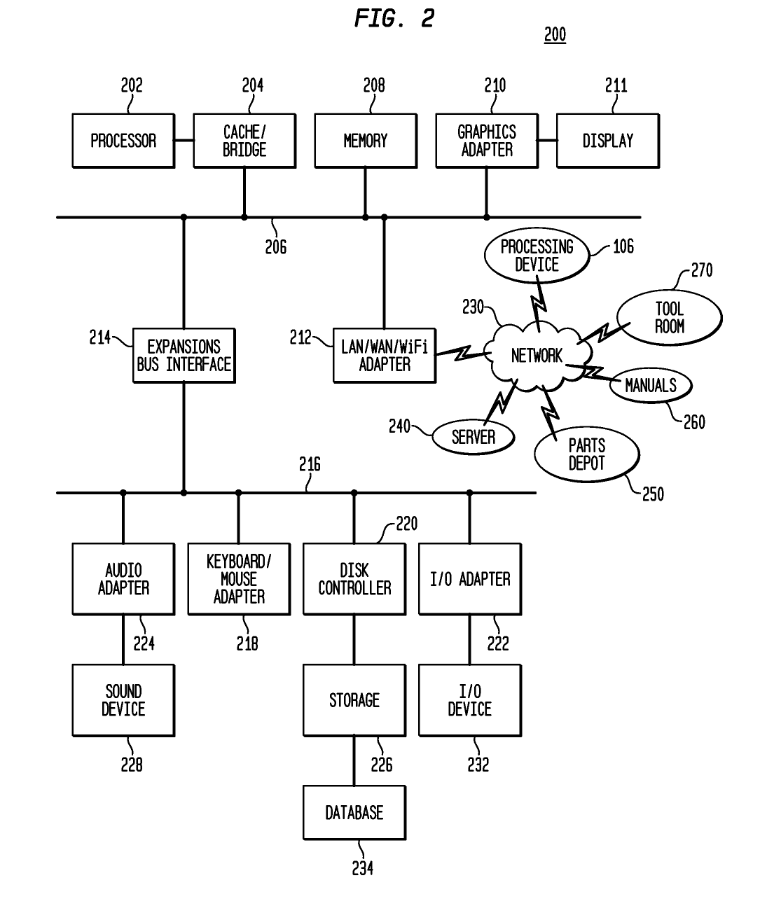

FIG. 2 depicts a block diagram of a data processing system 200 in which an embodiment can be implemented, for example, as the back-end workflow manager configured to perform image recognition, lookup, workflow, and other processes as described herein. The data processing system 200 includes a processor 202 connected to a level two cache/bridge 204, which is connected in turn to a local system bus 206. The local system bus 206 may be, for example, a peripheral component interconnect (PCI) architecture bus. Also connected to the local system bus 206 in the depicted example are a main memory 208 and a graphics adapter 210. The graphics adapter 210 may be connected to a display 211.

Other peripherals, such as a local area network (LAN)/Wide Area Network/Wireless (e.g. WiFi) adapter 212, may also be connected to the local system bus 206. An expansion bus interface 214 connects the local system bus 206 to an input/output (I/O) bus 216. The I/O bus 216 is connected to a keyboard/mouse adapter 218, a disk controller 220, and an I/O adapter 222. The disk controller 220 can be connected to a storage 226, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. The I/O adapter 222 can be connected to any number of input/output devices 232, including in particular the various peripherals and devices described herein.

Also connected to the I/O bus 216 in the example shown is an audio adapter 224, to which sound devices 228 are connected, including in particular an audio input such as a microphone for voice recognition processes and an audio output such as a speaker or headset connection for audio feedback to an operator. The keyboard/mouse adapter 218 provides a connection for a pointing device (not shown), such as a mouse, trackball, trackpointer, etc.

Those of ordinary skill in the art will appreciate that the hardware depicted in FIG. 2 may vary for particular implementations. For example, other peripheral devices, such as an optical disk drive and the like, also may be used in addition or in place of the hardware depicted. In some embodiments, multiple data processing systems may be connected and configured to cooperatively perform the processing described herein. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

The LAN/WAN/Wireless adapter 212 can be connected to a network 230 (not a part of data processing system 200), which can be any public or private data processing system network or combination of networks, as known to those of skill in the art, including the Internet. The data processing system 200 can communicate over the network 230 with a server system 240, which is also not part of the data processing system 200, but can be implemented, for example, as one or more separate data processing systems 200. Further, data processing system 200 can communicate over the network 230 with the processing device 106 described above.

Processing device 106 can be implemented, for example, as a data processing system 200 in a portable form factor. Scanning device 104 and processing device 106 can be integrated into a single physical unit. In some embodiments, scanning device 104 and processing device 106 are integrated into a non-portable scanning station.

Server system 240 can represent a number of different other data processing systems, including customer systems. Data processing system 200 can also communicate, for example over network 230, with a parts depot system 250, a repair data and manuals repository 260, and a tool room system 270. Any of these systems can be implemented on the same or different systems, can be commonly located, or can be located at different physical locations in various implementations.

The back-end subsystem shown in FIG. 2 can perform a number of actions, including object classification and workflow management.

An object classification process compiles all the raw data captured by the scanning device 104 in order to identity the targeted part. In various embodiments, this is done by a classification algorithm, but other embodiments can include 3D visual matching.

The object classification process breaks down the targeted part into discreet components considering physical characteristics such as size, positioning, quantity, coloring, etc., that may have been transmitted by processing device 106 to the data processing system 200. This process can also include separately identifying sub-parts of the target part, as described below. The data processing system 200 can also perform other functions, such as determining the size and shape of the target object, performing an optical character recognition (OCR) process on the images to extract textual information such as product numbers and labels, identifying the target part 102 and any constituent parts, and otherwise.

For example, using the motor part shown as target part 102, the classification algorithm could identify the following physical characteristics of the target part 102:
1 cylinder, gray in color, measuring a radius of 3.5 inches, length 10 inches;
1 cylinder, gray in color, measuring 1 radius of 0.1 inches, length 1.5 inches, connected to one of the flat ends of the larger cylinder;
1 rectangular box, dark gray in color, measuring 2×2×1, positioned on the curved surface of the large cylinder;
The part is positioned in machine XYZ, at location 123.

Note that this classification data includes physical characteristics of the identified sub-parts of the motor part.

From this classification data, a pre-populated database 234, for example in storage 226 or memory 208, is searched for parts that match these criteria and so identify the part. If more than one potential matching part is found, a listing, in likeliest order, can be transmitted to the processing device 106 to be presented to the user. The user can then select the part(s) they desire, and that selection can be transmitted back to and received by data processing system 200.

Once a part is selected, the Workflow Manager process produces a part requisition corresponding to the identified part, and sends the requisition to a parts depot system to inform a worker that the part is to be pulled. The parts depot system is also notified of supplementary parts that might also be required, and the worker can then pull all of these from stock and set them aside. When this has been accomplished, the parts depot system can indicate to the Workflow Manager process that the parts are ready to be picked up, and the Workflow Manager process can notify a technician via some configurable notification, such as by cell phone, the processing device 106, a PA system, etc., of the task that is to be performed.

Additionally, the Workflow Manager process or the parts depot system can automatically subtract those parts that are pulled from the shelves from an inventory listing, and if the inventory falls below a configurable threshold, one of those systems can include the parts in the a reorder report.

If specialized tools are required to install the selected (or identified) part, a tool room system can be notified to pull the required tools from the shelves to make these ready for the technician. Once the tools are pulled, the Workflow Manager process can be updated and the technician can be notified similar as described above. These tools can be checked out to a specific technician until they are returned to inventory.

Further, the pertinent sections of the repair manual for the selected or identified part can be downloaded to a portable system such as a laptop computer, tablet computer, the processing device 106, cell phone, or similar device carried by the technician.

When the repair is finished, the technician completes a form on the portable system, and this form is transmitted back to the Workflow Manager process. The Workflow Manager process updates a maintenance record for that specific target part 102 or its associated machine. The return can also allow additional feedback from the technician to the Workflow Manager system. For example, the Technician may provide additional notes that aided in the repair.

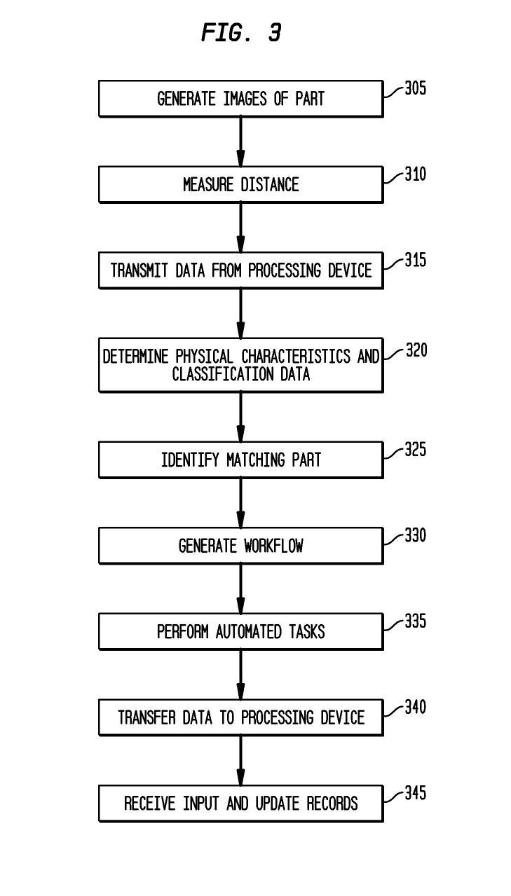

FIG. 3 depicts a flowchart of a process in accordance with disclosed embodiments. The steps below are performed by the “system”, which is intended to refer to the various elements of the front-end subsystem and the back-end workflow manager, and the connected systems, as described above.

The system generates at least one image of a target part using a scanning device (step 305). This step can include projecting a surface grid on the target part and generating one or more images that includes the grid and one or more images that does not include the grid.

The system can determine the distance between the scanning device and the target part (step 310). This can include measuring the distance, for example when using a handheld scanning device, or retrieving a known distance when using a stationary scanning device.

The system can then transmit the collected data from the processing device to the data processing system (step 315).

The system analyzes the images of the target part to determine classification data based on physical characteristics of the target part (step 320). This step can include identifying sub-parts of the target part and classification data for each of the sub-parts. The physical characteristics can include such elements as size, shape, color, location or position relative to other parts or sub-parts, location or position geographically or with relation to a specific facility, quantity, printed indicia, and others. The size of the part or subparts can be determined, in some embodiments, using the measured distance or the image of the projected surface grid. The shape of the part can also be determined, in some embodiments, using the image of the projected surface grid.

The system searches a parts database to identify a part that matches the classification data (step 325). This step can include, if more than one part potentially matches the classification data, displaying the potentially matching parts to a user and receiving a user selection of the correct matching part. The potentially matching parts can be displayed to a user in a “most-likely match” to “least-likely match” order.

The system generates a workflow based on the identified matching part (step 330). The workflow can include an identification of what service or maintenance can or should be performed on the part, a part requisition, an identification of supplementary parts, a notification to a technician or other user of a task to be performed, an inventory adjustment, a part reorder, an identification of tools required to service the matching part, a checkout of the identified tools to the technician or other user, and a service or repair manual to be transmitted to the technician or other user. This step can include performing any automated tasks identified by the workflow step 335), such as actually retrieving and sending the service manual to the technician and others. These processes can be performed by appropriate subsystems.

All the pertinent data can then be transmitted from the data processing system to the processing device (step 340).

The system can receive an input from the technician or other user and update service records accordingly (step 345). This input can include such elements as the specific part or parts that were serviced, the result of the service, any other parts that were replaced or consumed, any other service issues that were noted, whether the tools were checked back in, etc.

Processes as described herein therefore provide an efficient way for a user to simply scan a part to be serviced and allow the system to identify the part, determine what services, tools, and other parts are required, dispatch a technician, and give the technician the information, tools, and additional parts required to maintain the part.

it is important to note that while the disclosure includes a description in the context of a fully functional system, those skilled in the art will appreciate that at least portions of the mechanism of the present disclosure are capable of being distributed in the form of a computer-executable instructions contained within a machine-usable, computer-usable, or computer-readable medium in any of a variety of forms to cause a system to perform processes as disclosed herein, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs). In particular, computer readable mediums can include transitory and non-transitory mediums, unless otherwise limited in the claims appended hereto.

Although an exemplary embodiment of the present disclosure has been described in detail, those skilled in the art will understand that various changes, substitutions, variations, and improvements disclosed herein may be made without departing from the spirit and scope of the disclosure in its broadest form. In the processes described above, various steps may be performed sequentially, concurrently, in a different order, or omitted, unless specifically described otherwise. Further, various processes and functions performed by the data processing system described herein could also or alternately be performed by the processing device.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for automatic part identification and workflow generation, comprising:
generating at least one image of a target part using a scanning device;
analyzing the at least one image of the target part to determine classification data based on physical characteristics of the target part, the physical characteristics including a size and shape of the target part;
searching a parts database to identify a part that matches the classification data; and
generating a workflow based on the identified matching part, including an identification of a maintenance to be performed on the matching part.

2. The method of claim 1, wherein generating at least one image includes projecting a surface grid on the target part and generating a first image that includes the surface grid and a second image that does not include the surface grid.

3. The method of claim 2, wherein the shape of the target part is determined using the first image that includes the surface grid.

4. The method of claim 2, further comprising determining a distance between the scanning device and the target part.

5. The method of claim 4, wherein the size of the target part is determined using the determined distance and the first image that includes the surface grid.

6. The method of claim 1, wherein the physical characteristics also include at least one of a color of the target part, a location of the target part relative to other parts or sub-parts, a location of the target part geographically, a location of the target part with relation to a specific facility, a quantity of the target part, or printed indicia on the target part.

7. The method of claim 1, wherein identifying a part that matches the classification data includes displaying a plurality of potentially matching parts to a user and receiving a user selection of the correct matching part.

8. The method of claim 1, wherein the workflow also includes at least one of a part requisition, an identification of supplementary parts, a notification to a technician of a task to be performed, an inventory adjustment, a part reorder, an identification of tools required to service the matching part, a checkout of the identified tools to the technician, or a service manual to be transmitted to the technician.

9. The method of claim 1, further comprising automatically performing any automated tasks identified by the workflow.

10. The method of claim 1, further comprising receiving an input from a technician and updating service records according to the input.

11. An automatic part identification and workflow generation system, comprising:
a scanning device;
at least one processor; and
a storage that stores a parts database, the automatic part identification and workflow generation system configured to:
generate at least one image of a target part using the scanning device;
analyze the at least one image of the target part to determine classification data based on physical characteristics of the target part, the physical characteristics including a size and shape of the target part;
search the parts database to identify a part that matches the classification data; and
generate a workflow based on the identified matching part, including an identification of a maintenance to be performed on the matching part.

12. The system of claim 11, wherein generating at least one image includes projecting a surface grid on the target part and generating a first image that includes the surface grid and a second image that does not include the surface grid.

13. The system of claim 12, wherein the shape of the target part is determined using the first image that includes the surface grid.

14. The system of claim 12, wherein the system is also configured to determine a distance between the scanning device and the target part, and the size of the target part is determined using the determined distance and the first image that includes the surface grid.

15. The system of claim 11, wherein the physical characteristics also include at least one of a color of the target part, a location of the target part relative to other parts or sub-parts, a location of the target part geographically, a location of the target part with relation to a specific facility, a quantity of the target part, or printed indicia on the target part.

16. The system of claim 11, wherein identifying a part that matches the classification data includes displaying a plurality of potentially matching parts to a user and receiving a user selection of the correct matching part.

17. The system of claim 11, wherein the workflow also includes at least one of a part requisition, an identification of supplementary parts, a notification to a technician of a task to be performed, an inventory adjustment, a part reorder, an identification of tools required to service the matching part, a checkout of the identified tools to the technician, or a service manual to be transmitted to the technician.

18. The system of claim 11, wherein the system is also configured to automatically perform any automated tasks identified by the workflow.

19. The system of claim 11, wherein the system is also configured to receive an input from a technician and updating service records according to the input.

20. A non-transitory computer readable medium having program instructions stored thereon executable by one or more processors to:
generate at least one image of a target part using a scanning device;
analyze the at least one image of the target part to determine classification data based on physical characteristics of the target part, the physical characteristics including a size and shape of the target part;
search a parts database to identify a part that matches the classification data; and
generate a workflow based on the identified matching part, including an identification of a maintenance to be performed on the matching part.
